(19) United States
(12) Patent Application Publication
(10) Pub. No.: US 2017/0257330 A1
(43) Pub. Date: Sep. 7, 2017

(54) METHOD AND SYSTEM FOR STRUCTURED MESSAGING

(71) Applicant: Smartpager Systems Inc., Victoria (CA)

(72) Inventor: Russell Benjamin Moore, Victoria (CA)

(21) Appl. No.: 15/448,226

(22) Filed: Mar. 2, 2017

Related U.S. Application Data
(60) Provisional application No. 62/303,226, filed on Mar. 3, 2016.

(51) Int. Cl. H04L 12/58

(52) U.S. Cl. CPC H04L 51/046; H04L 51/08; H04L 51/14; H04L 51/26

(57) ABSTRACT

Various parameters are required to be defined for messages before they can be sent, which results in structured messaging. Structured messages may be routed and/or redirected according to rules, which may be time-dependent rules, content based rules or other rules. Further messages may be automatically created depending on a statistical analysis of similar types of structured messages over a period of time.

### CROSS-REFERENCE TO RELATED APPLICATIONS

This application claims the benefit of U.S. provisional patent application Ser. No. 62/303,226, filed on Mar. 3, 2016, which is incorporated by reference herein in its entirety.

### COPYRIGHT MATERIAL

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This application relates to a method and system for sending messages. More particularly, this application relates to a framework for preparing, sending, receiving and analyzing structured messages.

### BACKGROUND

Telephones, pagers and call centers are commonly used for communications in hospital environments, for example. Lately, there have also been internet-based systems that purport to replace the traditional paging system with smart phone applications.

This background information is provided to reveal information believed by the applicant to be of possible relevance to the present invention. No admission is necessarily intended, nor should be construed, that any of the preceding information constitutes prior art against the present invention.

### SUMMARY OF INVENTION

The present invention is directed to a method and system for structured messaging, in that various content fields are required to be completed for the messages before they can be sent. Furthermore, messages may be redirected according to rules, which may in some cases be time-dependent rules. Finally, other actions may be taken depending on a statistical analysis of similar types of messages over a period of time. The invention may be used to replace traditional phone and/or pager systems and even call centers, and to provide a more advanced solution in healthcare environments, for example, than services that only provide secure messaging.

Disclosed herein is a processor-implemented method for sending a structured message, the method comprising: receiving, by one or more processors, a definition of a schema that includes a message type and one or more required content fields; storing, by said processors, the schema in a computer readable memory; receiving, by said processors, a request to compose a message; receiving, by said processors, an addressee of the message; receiving, by said processors, a subject of the message, wherein the subject corresponds to said message type; retrieving, by said processors, said fields from said memory; presenting, by said processors, said fields to a sender of the message; requiring, by said processors, input of content for each of said fields before sending the message; receiving, by said processors, input of content for each of said fields; and sending, by said processors, the message as a structured message that includes the subject and the content input for each of said fields.

The method may further comprise: monitoring multiple structured messages of the same type; determining an average metric for said monitored messages; and when said average metric passes a predetermined threshold, automatically generating and sending a further message that relates to said threshold being passed. In some embodiments, the metric is a time taken to respond to a structured message.

Also disclosed herein is a computer readable medium comprising computer readable instructions, which, when processed by one or more processors, cause said processors to: receive a definition of a schema that includes a message type and one or more required content fields; store the schema in a computer readable memory; receive a request to compose a message; receive an addressee of the message; receive a subject of the message, wherein the subject corresponds to said message type; retrieve said fields from said memory; present said fields to a sender of the message; require input of content for each of said fields before sending the message; receive input of content for each of said fields; and send the message as a structured message that includes the subject and the content input for each of said fields.

Still further disclosed is a system for sending a structured message comprising: a server; a computer readable memory in the server that stores a definition of a schema that includes a message type and one or more required content fields; a sending user device; and one or more receiving user devices configured to receive said sent structured message. The sending user device is configured to: receive a request to compose a message; receive an addressee of the message; receive a subject of the message, wherein the subject corresponds to said message type; retrieve said fields from said memory or from further computer readable memory in the sending user device; present said fields to a sender of the message; require input of content for each of said fields before sending the message; receive input of content for each of said fields; and send the message as a structured message that includes the subject and the content input for each of said fields.

### BRIEF DESCRIPTION OF DRAWINGS

The following drawings illustrate embodiments of the invention, which should not be construed as restricting the scope of the invention in any way.

FIG. 1 is a schematic diagram showing a structured messaging system according to an embodiment of the present invention.

FIG. 2 is a flowchart of a method for structured messaging undertaken by the structured messaging system in accordance with some implementations of the present invention.

FIG. 3 is a screen shot of different routing rule sets according to an embodiment of the present invention.

FIG. 4 is a screen shot for defining a routing rule according to an embodiment of the present invention.

FIG. 5 is a screen shot of a routing rule schedule according to an embodiment of the present invention.

FIG. 6 is a screen shot for preparing a message according to an embodiment of the present invention.

FIG. 7 is a screen shot showing preparation of a structured message according to an embodiment of the present invention.

FIG. 8 is a screen shot for setting up a phone message routing plan according to an embodiment of the present invention.

FIG. 9 is a screen shot showing message analytics, according to an embodiment of the present invention.

FIG. 10 is a screen shot of an on-call schedule according to an embodiment of the present invention.

FIG. 11 is a flowchart of a more detailed method for structured messaging undertaken by the structured messaging system in accordance with some implementations of the present invention.

### DESCRIPTION

### A. Glossary

The term “firmware” includes, but is not limited to, program code and data used to control and manage the interactions between the various modules of the system.

The term “hardware” includes, but is not limited to, the physical housing for a computer as well as the display screen, connectors, wiring, circuit boards having processor and memory units, power supply, and other electrical components.

The term “hospitalist” refers to a doctor who works in a hospital.

The term “module” can refer to any component in this invention and to any or all of the features of the invention without limitation. A module may be a software, firmware or hardware module, and may be located in a user device or a server.

The term “network” can include both a mobile network and data network without limiting the term's meaning, and includes the use of wireless (e.g. 2G, 3G, 4G, WiFi, WiMAX™, Wireless USB (Universal Serial Bus), Zigbee™, Bluetooth™ and satellite), and/or hard wired connections such as internet, ADSL (Asymmetrical Digital Subscriber Line), DSL (Digital Subscriber Line), cable modem, T1, T3, fiber, dial-up modem, television cable, and may include connections to flash memory data cards and/or USB memory sticks where appropriate. A network could also mean dedicated connections between computing devices and electronic components, such as buses for intra-chip communications.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, whether they are explicitly described as being executed by the processor or whether the execution thereby is implicit due to the steps being described as performed by code or a module. The processor, if comprised of multiple processors, may be located together or geographically separate from each other. The term includes virtual processors and machine instances as in cloud computing or local virtualization, which are ultimately grounded in physical processors.

The term “software” includes, but is not limited to, program code that performs the computations necessary for calculating and optimizing user inputs, creating messages, routing messages, the reporting and analysis of message data, displaying information, and, managing of input and output data.

The term “structured message” means a message that has predefined fields that form part of the content of the message, where the number and type of the fields depend on the type of the message. The fields are required to be completed before the message can be sent. In contrast to a traditional or more casual message such as an email, which has a free text component for the message content, a structured message forces some of the message content to be included in the predefined fields. The predefined, required content fields are different from the title or subject field of the message. A structured message may also be considered to be a form-based message.

The term “system” when used herein refers to a system for structured messaging, the system being the subject of the present invention. The system is able to manage the definition of addressees, the required content fields (or parameters) for structured messages, the sending and receiving of messages and the actions to take based on particular messages or on message analytics.

The term “user” refers to a person who uses the system or interacts with it via a user device. There may be different types of user, such as a user who sends messages, a user who receives messages, an administrator who sets up groups of users, or a manager or other user who defines structured message schemata, message-based rules, parameters and actions for example. An end user generally refers to a person other than an IT (information technology) administrator. Users may have different roles within the organization that uses the structured messaging system. Users may also be outside the organization, such as patients, relatives and third party lab technicians, who may not be part of a hospital that uses the system.

### System

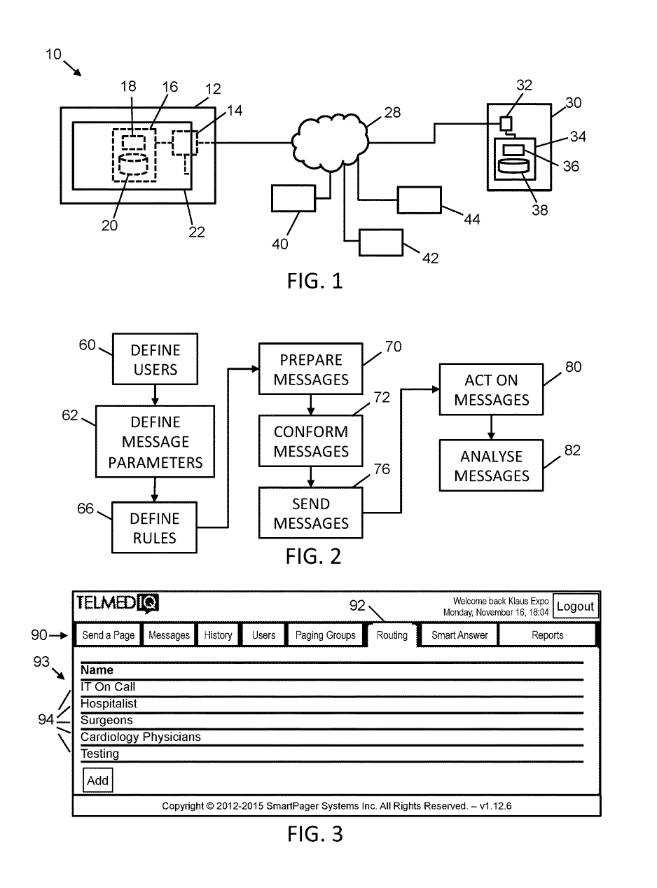

Referring to FIG. 1, there is shown an exemplary embodiment of a structured messaging system 10 in accordance with the processor-implemented invention described herein. The system 10 includes or interacts with a user computing device 12, which may be a tablet, laptop, smartphone or desktop computer, for example, or any other electronic device that provides the necessary equivalent functionality to fulfill the requirements of the system. The user device 12 includes one or more processors 14 which are operably connected to computer readable memory 16 included in the device. The system 10 includes computer readable instructions 18 (e.g. an application) stored in the memory 16 and computer readable data 20, also stored in the memory. The memory 16 may be divided into one or more constituent memories, of the same or different types. The user device 12 includes a display screen 22, operably connected to the processor(s) 14. The display screen 22 may be a traditional screen, a touch screen, a projector, an electronic ink display or any other technological device for displaying information.

The user device 12 is connected to or into the system 10 via a network 28, which may, for example, be the internet, a telecommunications network, a local area network, a bespoke network or any combination of the foregoing. Communications paths in the network 28 may include any type of point-to-point or broadcast system or systems.

The system 10 also includes a server 30, which has one or more processors 32 operably connected to a computer readable memory 34, which stores computer readable instructions 36 and computer readable data 38. Data 38 may be stored in a relational database, for example. Some or all of the computer readable instructions 18, 36 and computer readable data 20, 38 provide the functionality of the system 10 when executed or read by the processors 14, 32. Computer readable instructions may be broken down into blocks of code or modules.

Other users may have further user devices 40, 42, 44 with functionally equivalent components to those of device 12, which may also be part of, or connected to, the system 10. User devices 40, 42, 44 may be portable or non-portable computing terminals, or they may be telephones. In addition, one or more IVRs (Interactive Voice Responders) may be connected to the system 10.

### C. Overview of Functionality

Referring to FIG. 2, the main steps of a method for structured messaging carried out by the system 10 are shown in a flowchart.

In step 60, the system 10, based upon input from an administrator, for example, defines the end users who will interact with the system. The users may be individuals and groups of individuals who will send and/or receive structured messages. Individuals may appear as individuals and may also be in one or more groups. Details of the individuals are stored in memory 34 as part of data 38.

In step 62, the message parameters are defined, either by an end user or an administrator. For example, only certain predefined types of messages (i.e. structured messages) may be permitted in the system, or they may be permitted in addition to more traditional messages, which are unstructured. For example, when defining a particular type of structured message, one or more fields may be added to a schema for the message type. For example, if a message type were being defined for new patient admissions to a hospital, then the fields that would be added to the schema would be, for example, Patient Name, Patient Location, Reason for Admission, and Patient Condition. These fields may be defined in the schema as required content fields. A user then sending an Admission type message using email software would then be obliged to complete the fields before being able to send the message.

Equivalent parameters may be defined for messages that are received by telephone, for example by using an IVR in conjunction with touch-tone inputs received from the phone, and a speech-to-text converter. Likewise, messages that are machine generated, e.g. from within the system 10, are configured to obey the corresponding message schemata.

Hybrid messages are also possible, which can be created by a user and a machine. For example, a structured message may have required fields of which some are automatically machine-populated as soon as a patient name is entered in the patient name field. The data used to automatically populate the fields for the patient's condition can be pulled from the particular patient's medical health record, and the patient's location can be retrieved from a database containing all patient locations within a hospital. Data for completing the required fields may be pulled from data 38 or from a third party system connected to system 10. Required content fields may be configured to be completed by free text or by a choice from a pull-down list of predefined options. For example, a patient's condition field may be configured to provide the choices of critical, declining, stable or improving. Other fields are possible, such as ones that capture dates, times, time periods, any other choices, Boolean fields, etc.

In step 66, one or more of the users (e.g. an end user or an IT administrator) of the system 10 define the routing rules, which are stored by the system as part of the data 38. Rules may be based, for example, on various policies in force in a hospital. For example, a routing rule may be: “After 7pm, if patient Smith's blood result comes back abnormal send the message to the division chief instead of the hospitalist on call.” Another example may be: “If a message is addressed to a specific doctor who is not on-call, then redirect the message to the doctor currently on call”. To determine whether the system 10 should redirect such messages, it consults a schedule that may be, for example, managed by a hospital personnel administrator. This eliminates the requirement for doctors to set up their own message forwarding at the end of each of their on-call shifts. Other examples would be to forward calls to multiple doctors that are on call system on a round robin basis. In other embodiments, the messages may be distributed according to the doctors' availability, which may be determined from messages the doctors themselves send to the system 10 during their examination or treatment of patients, or upon completion thereof.

Message routing rules are based, for example, on the content or parameters input in the required fields of the structured messages. Message routing rules can be based on some, all or any of:
a. Time of day, and/or day of the week, and/or whether the day is a statutory holiday.
b. Timers on certain conditions, for example: if a message has not been read within 10 minutes of its being sent; if a message has not been acknowledged within 20 minutes of its being sent; or if a message has not been delivered within 5 minutes of its being sent.
c. Who or what, in the case of a machine-generated message, is sending the message.
d. Who or what, in the case of auto-responder devices, are the recipients of the message.
e. Who is on call in a certain call schedule, which may be a call schedule in system 10 or in a third party's system.
f. The subject of a structured message.
g. The subject or content of an unstructured message, if such messages are permitted to be sent within the system 10.
h. The contents of the message, for example, whether a patient's condition is declining, whether the message is marked as critical, or whether a particular keyword is found in an automated speech to text conversion.
i. The name of the patient whom the message is about.
j. Information in a patient's health record, such as a critical lab. For example this could be an EMR (Electronic Medical Record) or HER (Health Record)
k. The urgency of the message.

In step 70, end users of the system 10 prepare messages to be sent using the system. While different kinds of messages are possible, including email, text, form, voice message, machine generated or hybrid, the description herein largely focuses on email style messages.

In step 72, the messages that are being composed are conformed to the corresponding schemata for the messages. The type of message may be selected during the composition of the message. For example, a user may start writing the subject of a message in a subject field, and a list of possible subjects may automatically be displayed, from which the user then selects one. Once a particular type of message has been determined by the system 10, the required fields that correspond to the chosen message type are automatically displayed on the user's screen. As noted above, the required fields may be automatically populated depending on the contents of one or more other fields, or they may be completed manually. If a user attempts to send a message before all the required fields are completed, then the message will not be sent and the user will be given a prompt to complete the incomplete fields.

In step 76, the system 10 sends the messages to the addressees, which may be individual users, groups of users or both individuals and groups. The messages may be sent as addressed or, in step 80, the system may act upon the messages. For example, the system 10 may act upon the messages to redirect them immediately upon their sending, based on one or more of the routing rules that have been previously defined. Other messages may be redirected conditionally depending on whether they are delivered within a certain time, viewed within a certain time, or responded to within a certain time.

In step 82, the messages that have been sent are analyzed to reveal trends across multiple communications. The system 10 is able to accept macro rules based on analytics, such as the rule: “If the average time to respond to a new admission exceeds 5 minutes, send a new message to the division chief.” This would be a machine-generated message created by the system 10. If the division chief received such a message then he would be able to take action to improve the situation, such as bringing in extra personnel to reduce the delays. Sending this type of message would be far more economical and useful than the division chief being notified in real time about every single case that exceeded 5 minutes. The averaging of data can be calculated over a configurable time period.

### D. Screen Shots of Exemplary Embodiment

Referring to FIG. 3, a screen shot of the routing rule sets is shown as would be seen by an administrator. Various management tabs 90 are available and it is the Routing tab 92 that is currently selected. The other tabs are: Send a Page (i.e. a message, which may be a structured message); Messages, which include messages sent, received and organized into folders and subfolders, for example; History; Users, which is a list of the individual users registered to use the system 10; Paging Groups, which contains a list of the different groups of users to which messages can be sent; Smart Answer, for defining how structured messages are generated from calls that are received by phone; and Reports, which show analytical data based on multiple messages.

The Routing tab 92, when selected, shows the list 93 of rule sets that have been defined in the system 10. For example, there is a set of routing rules for messages related to IT (Information Technology) on call. Below this there is a set of routing rules related to hospitalists (i.e. doctors in hospitals). Further sets of routing rules relate to other areas of the hospital such as surgeons, cardiologists and testing. Each set of rules is accessed by clicking on the corresponding heading 94 for the set of rules. A set of rules may include one or more rules.

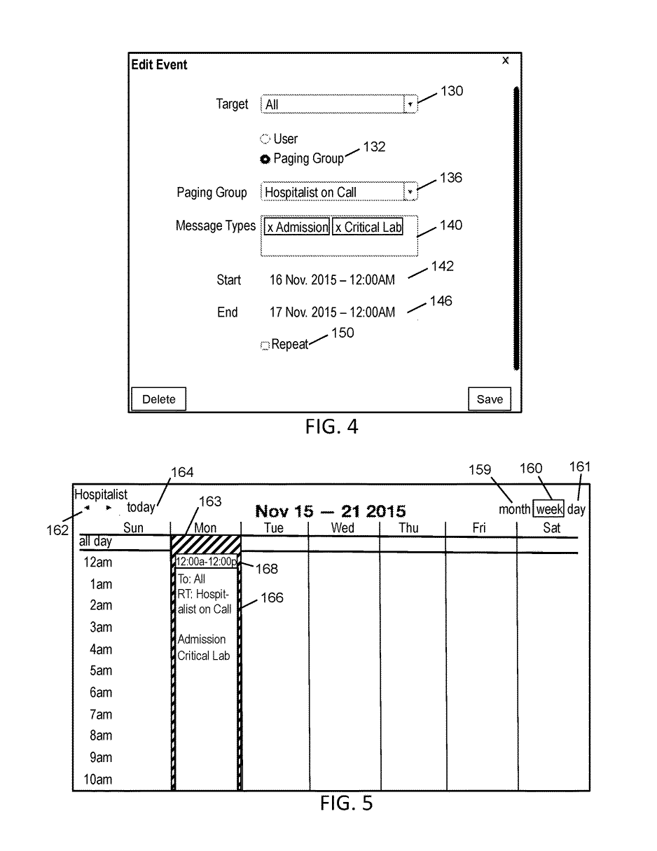

Referring to FIG. 4, a screen shot of setting up a routing rule is shown. Box 130 shows the addressees of the messages that are to be subjected to the routing rule. In this case, “All” has been selected from a pull-down menu. In other cases, individuals or groups could be selected. Selected button 132 shows that the messages are to be routed to a paging group, defined by the selection in pull-down menu 136. Box 140 shows the types of messages that the routing rule applies to, which in this case are Admissions and Critical Labs. Box 142 allows the user to define the time of the start of the rule, and box 146 the end time of the rule. Box 150 allows the rule to be repeated at one or more times in the future. The rule specifies that messages addressed to any recipient (“To: All”), which are of the “Admission” or “Critical Lab” types are to be automatically routed to the hospitalist on call (RT: Hospitalist On Call”), through the day of Nov. 16, 2015.

Referring to FIG. 5, a week's view of a routing rule schedule is shown, as selected by the Week button 160. The schedule can be toggled to a month view or day view by adjacent buttons 159, 161 respectively. The day of focus 163 can be highlighted using left and right arrows 162, and the actual day is shown as “today” at 164. The rule 166 that is scheduled is in force from 12am to 12pm as shown in the title bar 168 of the rule. The rule specifies that messages addressed to any recipient (“To: All”), which are of the “Admission” or “Critical Lab” types are to be automatically routed to the hospitalist on call (RT: Hospitalist On Call”).

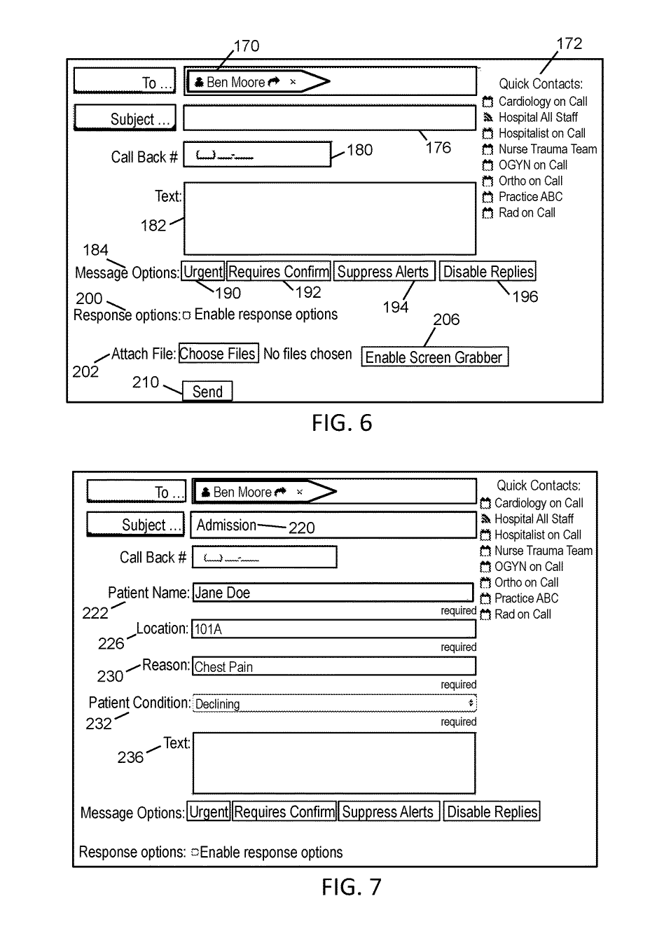

Referring to FIG. 6, a screen for composing a message is shown. It shows an addressee 170, who may be selected from a list 172 of quick contacts. A message title, or subject area 176 is shown. An area 180 for a call back number to be entered is included. The text area 182 is where the content of the message can be entered. Various option buttons 184 are shown. These are the level of urgency 190, whether confirmation is required 192, whether alerts are to be suppressed 194 and whether replies are to be disabled 196. Buttons may change color or shade when activated. Pre-set response options 200 can be enabled if desired. Files can be attached to the message at 202, such as images or other documents. Images on the screen can be captured with button 206 and then sent with the message or as part of it. The “send” button 210 can be clicked upon when the message is ready to be sent.

FIG. 7 shows the composition of a structured message of the Admission type 220, as defined here by writing Admission in the subject field of the message. In other embodiments, the message type could be selected from a pull-down menu. As the message type is Admission, required content fields are displayed, including Patient Name 222, Patient Location 226, Reason for admission 230 and Patient Condition 232. As the essential content of the message has been included in the required fields, there is no need for the composer of the message to write anything in the free-form text area 236, although this is still possible.

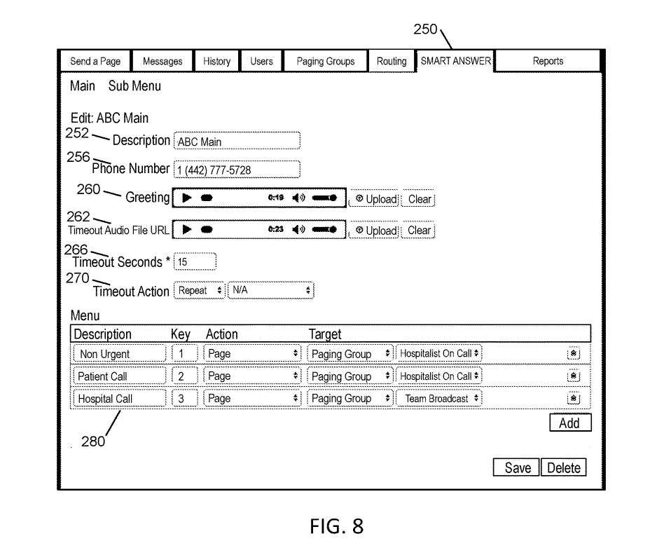

FIG. 8 relates to the kind of message that originates from a phone call. The Smart Answer tab 250 is selected, allowing the user to define actions based on voice calls. The description of the answer is input at box 252, and the phone number for which the answer applies at box 256. The initial greeting can be recorded using controls 260, and a further response can be set up using controls 262 in the case that no input is received from the caller within a preset timeout period 266. The action to be taken upon timeout can be defined using selection menu 270. Area 280 of the screen defines the actions to be taken depending on the type of message that the system 10 determines the incoming call to be. For example, the caller will be requested to type 1 on the phone pad if the message is non-urgent. As a result, messages of type 1 will be sent to the group of hospitalists on call. A patient who is calling will be requested to enter 2 on the phone pad, and these messages will also be sent to the hospitalist on call. If the call is originated by the hospital (e.g. management) then the caller will be asked to type 3 on the phone pad, and these messages will be sent to the group entitled “Team Broadcast”.

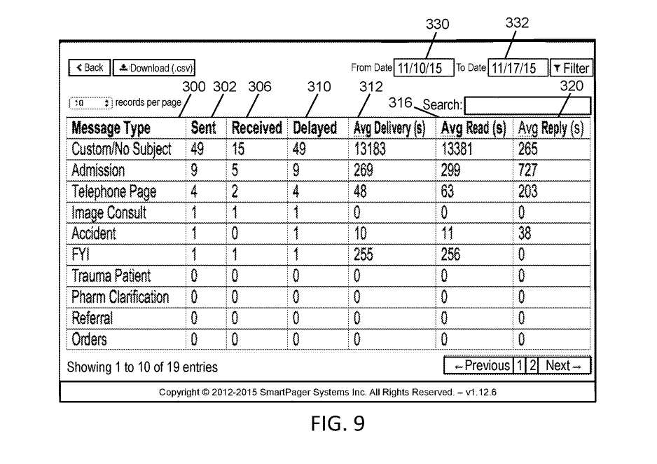

FIG. 9 is an example of structured message analytics, listed according to the type of message 300. For each type of structured message, data is displayed for the number of messages sent 302, the number of messages received 306, the number of messages delayed 310, the average delivery time in seconds 312 for the messages, the average time for the messages to be read (or opened) 316, and the average time for a reply to the messages to be sent 320, where replies have actually been sent. Data is displayed for a selectable time period, from a specified start date 330 to a specified end date 332. Data can be filtered and/or downloaded for further analysis.

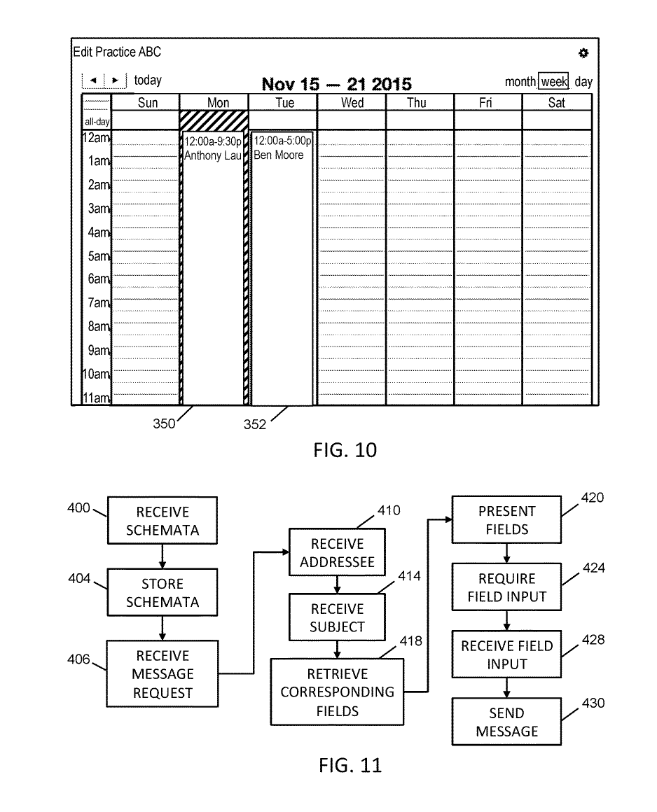

FIG. 10 shows a schedule for doctors on call. Other personnel can also be included in the schedule or another schedule. Here, one doctor is scheduled 350 to be on call on Monday from 12am to 9.30pm, and another doctor is scheduled 352 to be on call from 12am to 5pm on Tuesday. This schedule and other similar schedules are stored in memory 34 as part of data 38 in the system 10, and the schedules are used in conjunction with the routing rules for the structured messages.

### E. Detailed Flowchart

Referring to FIG. 11, the system 10 receives a definition for at least one schema for a particular type of structured message in step 400. The schema includes an identification of the type of the message and the definition of one or more required content fields. The type of the message allows the schema to be identified and used for future messages that have the same type of message specified in their subject fields. The content fields are separate and distinct from the subject field or type of the message. In step 404, the system 10 stores the schemata that have been defined in memory 34, for example in data 38.

In step 406, the system 10 receives a request to create a new message, for example from a user using an application on user device 12, or via a phone request. In step 410, the system 10 receives an addressee of the message, and in step 414, the system receives a subject for the message, which corresponds to a type of a message for which there is a schema stored in the database 38.

In step 418, the system 10 retrieves from the data 38 the required content fields (e.g. 222, 226, 230, 232) in the schema for the particular type of the message specified by the subject that has been input by the user in the prior step 414. The schemata may also be stored locally as part of data 20. In step 420, the required content fields are presented to the user, for example on the screen 22 of the user device 12 or verbally via a phone-type interface. In step 424, the system requires the input of content in the required content fields before the message can be sent, even if the user desires to send the message. A prompt may be given to the user that the fields are required, e.g. by displaying the fact that the fields are required on the screen. The “send” button may be grayed out until all the required content fields are completed.

In step 428, the system 10 receives input of the content for the required content fields, and then, when the user taps the “send” button, sends the message in step 430. The message that is sent is a structured message that includes the subject and the content in each of the required content fields. The message can either be sent to the addressee or a recipient other than the addressee, or both, depending on various routing rules that have been input into the system.

### F. Variations

Routing rules may be based on parameters or conditions other than the ones specifically mentioned above. The system 10 may be configurable so that administrators can define their own parameters and conditions, and the structure of the messages.

In general, unless otherwise indicated, singular elements may be in the plural and vice versa with no loss of generality. The use of the masculine can refer to masculine, feminine or both.

Throughout the description, specific details have been set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware, firmware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

Although the present invention has been illustrated principally in relation to hospital and healthcare delivery environments, it has application in respect of other areas, such as corporate environments, government environments, city management, etc.

It will be clear to one having skill in the art that variations to the specific details disclosed herein can be made, resulting in other embodiments that are within the scope of the invention disclosed. Steps in the flowcharts may be performed in a different order, other steps may be added, or one or more may be removed without altering the main function of the system. Screen shots may show more or less than the examples given herein. All parameters and configurations described herein are examples only and actual values of such depend on the specific embodiment. Accordingly, the scope of the invention is to be construed in accordance with the substance defined by the claims.

1. A processor-implemented method for sending a structured message, the method comprising:
receiving, by one or more processors, a definition of a schema that includes:
a message type; and
one or more required content fields;
storing, by said processors, the schema in a computer readable memory;
receiving, by said processors, a request to compose a message;
receiving, by said processors, an addressee of the message;
receiving, by said processors, a subject of the message, wherein the subject corresponds to said message type;
retrieving, by said processors, said fields from said memory;
presenting, by said processors, said fields to a sender of the message;
requiring, by said processors, input of content for each of said fields before sending the message;
receiving, by said processors, input of content for each of said fields; and
sending, by said processors, the message as a structured message that includes the subject and the content input for each of said fields.

2. The method of claim 1, further comprising, prior to receiving the subject, said processors presenting to the sender a subject list from which the subject is selected, wherein each subject on the list corresponds to a different message type, and each message type has a corresponding schema stored in said memory.

3. The method of claim 1, further comprising:
receiving further content as free text; and
including said free text in the structured message that is sent.

4. The method of claim 1, further comprising said processors automatically populating at least one of said fields with content in response to, and based on, content input in another of said fields.

5. The method of claim 1, further comprising said processors automatically populating a patient location field and a patient condition field in response to a patient name being input in a patient name field.

6. The method of claim 1, wherein said processors send the structured message to the addressee.

7. The method of claim 6, wherein the addressee is a hospitalist on call.

8. The method of claim 6, wherein when the structured message is not received, acknowledged, viewed, or responded to within a predetermined amount of time from sending the structured message, the method further comprises said processors sending the structured message to a recipient other than the addressee.

9. The method of claim 1, wherein the addressee is a hospitalist on call and the structured message is sent to one of a plurality of hospitalists on call selected either based on a round robin scheme or based on availability of said hospitalists.

10. The method of claim 1, wherein said processors send the structured message to a recipient other than the addressee, the other recipient determined according to a rule that is based on one or more of:
a current time of sending the structured message;
content in at least one of said fields;
a work schedule of the other recipient;
the subject of the structured message;
an identity of the sender;
an identity of the addressee; and
an urgency of the structured message.

11. The method of claim 1, wherein said processors send the structured message to a recipient other than the addressee, the other recipient determined according to a rule that is based on a patient identified in the content and an electronic medical record for said patient.

12. The method of claim 1, wherein said processors receive said request, said subject, said addressee and said content from an automated speech to text converter.

13. The method of claim 1, further comprising:
monitoring multiple structured messages of the same type;
determining an average metric for said monitored messages; and
when said average metric passes a predetermined threshold, automatically generating and sending a further message that relates to said threshold being passed.

14. The method of claim 13 wherein the metric is a time taken to respond to a structured message.

15. The method of claim 1, wherein at least some of the content is input as a selection from one or more lists of predefined options.

16. A computer readable medium comprising computer readable instructions, which, when processed by one or more processors, cause said processors to:
receive a definition of a schema that includes:
a message type; and
one or more required content fields;
store the schema in a computer readable memory;
receive a request to compose a message;
receive an addressee of the message;
receive a subject of the message, wherein the subject corresponds to said message type;
retrieve said fields from said memory;
present said fields to a sender of the message;
require input of content for each of said fields before sending the message;
receive input of content for each of said fields; and
send the message as a structured message that includes the subject and the content input for each of said fields.

17. A system for sending a structured message comprising:
a server;
a computer readable memory in the server that stores a definition of a schema that includes:
a message type; and
one or more required content fields;
a sending user device that is configured to:
receive a request to compose a message;
receive an addressee of the message;
receive a subject of the message, wherein the subject corresponds to said message type;
retrieve said fields from said memory or from further computer readable memory in the sending user device;
present said fields to a sender of the message;
require input of content for each of said fields before sending the message;
receive input of content for each of said fields; and
send the message as a structured message that includes the subject and the content input for each of said fields; and
one or more receiving user devices configured to receive said sent structured message.

18. The system of claim 17, wherein the sending user device receives at least some of said content as a vocal input from the sender.
